(19) United States
(12) Patent Application Publication
(10) Pub. No.: US 2021/0318346 A1
(43) Pub. Date: Oct. 14, 2021

(54) AUTOMATED ANALYZING APPARATUS

(71) Applicant: CANON MEDICAL SYSTEMS CORPORATION, Otawara-shi (JP)

(72) Inventors: Atsushi HOSOOKA, Otawara (JP); Naoto SATO, Nasushiobara (JP); Reiko MARUYAMA, Nasushiobara (JP); Mitsuo OKAMOTO, Nasushiobara (JP); Masaaki SAITOU, Nasushiobara (JP); Takahiro OMORI, Otawara (JP)

(73) Assignee: CANON MEDICAL SYSTEMS CORPORATION, Otawara-shi (JP)

(21) Appl. No.: 17/223,555

(22) Filed: Apr. 6, 2021

(30) Foreign Application Priority Data
Apr. 9, 2020 (JP) 2020-070414

(51) Int. Cl. G01N 35/00; G01N 35/02

(52) U.S. Cl. CPC G01N 35/00732; G01N 2035/00752; G01N 35/025; G01N 35/026

(57) ABSTRACT

An automated analyzing apparatus according to one embodiment comprises a barcode reader and a cylindrical lens. The barcode reader emits light toward a barcode attached to at least one of a specimen container storing a test sample, a reagent container storing a reagent to be reacted with the test sample, and a specimen rack housing a plurality of the specimen containers arranged in a line, and reads the barcode on the basis of reflected light of the applied light. The cylindrical lens is placed between at least one of the specimen container, the reagent container, and the specimen rack, and the barcode reader.

### CROSS-REFERENCE TO RELATED APPLICATIONS

This application is based upon and claims the benefit of priority from Japanese Patent Application No. 2020-070414, filed on Apr. 9, 2020; the entire contents of which are incorporated herein by reference.

### FIELD

Embodiments disclosed in the present specification and the drawings relate to an automated analyzing apparatus.

### BACKGROUND

An automated analyzing apparatus that optically measures changes in the color tone or the turbidity caused by a reaction of a mixed liquid including a test sample collected from a test body and a reagent for each of test items using a photometric unit such as a spectrophotometer or a nephelometer is conventionally known. In such an automated analyzing apparatus, analysis data represented by the concentrations of various test item components, the activity of enzymes, or the like in the test sample is generated on the basis of a measurement result.

The test sample is stored in a specimen container and the reagent is stored in a reagent container. A barcode indicating identification information for identifying the specimen or the reagent is attached to each of the containers. Therefore, a barcode reader that reads this barcode is included in the automated analyzing apparatus.

### BRIEF DESCRIPTION OF THE DRAWINGS

FIG. 1 is a perspective view illustrating a schematic configuration of an automated analyzing apparatus according to a first embodiment;

FIG. 2 is a block diagram illustrating a control configuration of the automated analyzing apparatus illustrated in FIG. 1;

FIG. 3 is a schematic plan view of a disk sampler;

FIG. 4A is a plan view schematically illustrating a configuration of a specimen container reading part and a reagent container reading part;

FIG. 4B is a plan view schematically illustrating a configuration of a specimen rack reading part;

FIG. 5 is a plan view schematically illustrating a configuration of a specimen container reading part and a reagent container reading part according to a second embodiment;

FIG. 6 is a plan view schematically illustrating a configuration of a specimen container reading part and a reagent container reading part according to a third embodiment;

FIG. 7 is a plan view schematically illustrating the configuration of the specimen container reading part and the reagent container reading part according to the third embodiment; and

FIG. 8 is a plan view schematically illustrating a configuration of a specimen container reading part and a reagent container reading part according to a fourth embodiment.

### DETAILED DESCRIPTION

The barcode reader receives reflected light when light is applied toward a barcode to read the barcode. At that time, the reading accuracy decreases, for example, when the reflected light diffuses.

One of the objects to be solved by embodiments disclosed in the present specification and the drawings is to improve the reading accuracy of barcodes. However, the problems to be solved by the embodiments disclosed in the present specification and the drawings are not limited to the above described problems. Problems to be resolved by each of effects by respective configurations in the embodiments described below may be also regarded as other problems.

An automated analyzing apparatus according to one embodiment comprises a barcode reader and a cylindrical lens. The barcode reader emits light toward a barcode attached to at least one of a specimen container storing a test sample, a reagent container storing a reagent to be reacted with the test sample, and a specimen rack housing a plurality of the specimen containers arranged in a line, and reads the barcode on a basis of reflected light of the applied light. The cylindrical lens is placed between at least one of the specimen container, the reagent container, and the specimen rack, and the barcode reader.

An embodiment will be explained below with reference to the accompanying drawings. The present invention is not limited to the embodiment. In the following descriptions, constituent elements having substantially identical functions and configurations as one another are denoted by like reference signs and redundant explanations thereof will be made only when necessary.

### First Embodiment

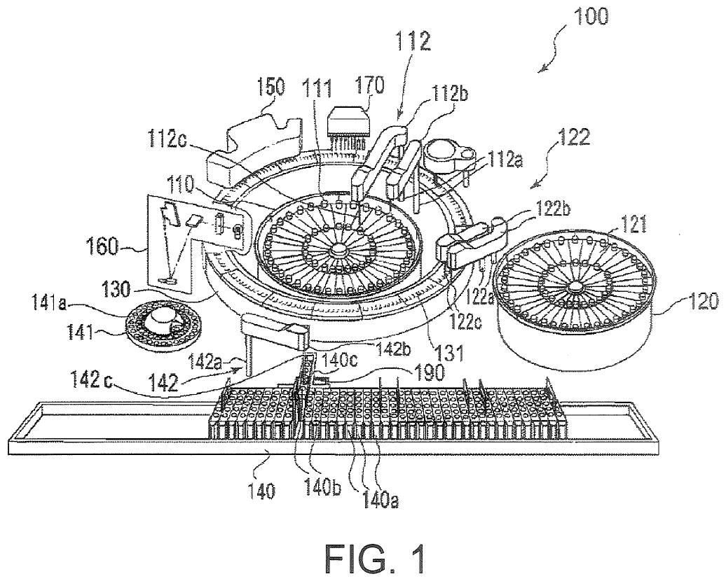

FIG. 1 is a perspective view illustrating a schematic configuration of an automated analyzing apparatus according to a first embodiment. As illustrated in FIG. 1, an automated analyzing apparatus 100 includes a first reagent storage 110 that houses a plurality of reagent containers 111, a second reagent storage 120 that houses a plurality of reagent containers 121, and a reaction disk 130 that is placed around the first reagent storage 110 and that houses a plurality of reaction containers 131.

The first reagent storage 110 has a rack portion (not illustrated) that enables the reagent containers 111 to be rotatable in a state housed therein. The reagent containers 111 are annularly arranged in the first reagent storage 110. A first reagent that reacts against a component of a specific item included in a test sample is in each of the reagent containers 111. A barcode indicating identification information of the first reagent is attached to the outer peripheral surface of each of the reagent containers 111.

The second reagent storage 120 is placed near the first reagent storage 110. The reagent containers 121 are annularly arranged in the second reagent storage 120 and a rack portion (not illustrated) where the reagent containers 121 are rotatably housed is provided therein. Various second reagents that react against components of specific items included in the test sample are respectively stored in the reagent containers 121. A barcode indicating identification information of each of the second reagents is also attached to the outer peripheral surface of the corresponding one of the reagent containers 121 similarly to the reagent containers 111.

The reaction disk 130 is formed in the shape of a circular ring so as to encompass the first reagent storage 110. The reaction containers 131 are arrayed in the manner of a circular ring on the reaction disk 130. The reaction containers 131 store a mixed liquid including a test sample and a reagent. The reaction disk 130 is rotated by a reaction disk driver 213 in a state housing the reaction containers 131.

An agitating unit 150, a photometric unit 160, and a reaction container cleaning unit 170 are provided around the reaction disk 130. The agitating unit 150 agitates the mixed liquid including the test sample and the reagent stored in the reaction containers 131. The photometric unit 160 generates standard data or test data represented, for example, by absorbance data on the basis of a detection signal that is obtained by detecting wavelength light of each of test items having transmitted through the mixed liquid when light is applied to the reaction containers 131. The reaction container cleaning unit 170 cleans the reaction containers 131 where measurement has been completed.

A first reagent arm 112, a second reagent arm 122, and a sampling arm 142 are provided around the reaction disk 130. The first reagent arm 112 has pivot shafts 112a substantially perpendicularly erecting around the reaction disk 130. Arm portions 112b extending in a direction substantially orthogonal to the erecting direction of the pivot shafts 112a are connected to upper ends of the pivot shafts 112a, respectively. The arm portions 112b are capable of respectively pivoting around the pivot shafts 112a. The pivot shafts 112a are provided to be capable of moving up and down (being lifted and lowered). A reagent probe 112c is connected to the head of each of the arm portions 112b.

Each of the reagent probes 112c is pivoted to be reciprocable at least between filling ports of the reagent containers 111 in the first reagent storage 110 and the reaction containers 131. Each of the reagent probes 112c is moved up and down along with the associated arm portion 112b by an up-and-down motion of the associated pivot shaft 112a. Each of the reagent probes 112c sucks the reagent from the filling ports of the reagent containers 111 in the first reagent storage 110 using a pump and ejects the sucked reagent into the reaction containers 131.

The second reagent arm 122 is provided between the reaction disk 130 and the second reagent storage 120. The second reagent arm 122 includes pivot shafts 122a, arm portions 122b, and reagent probes 122c similarly to the first reagent arm 112. Each of the reagent probes 122c is pivoted around the associated pivot shaft 122a via the associated arm portion 122b. Each of the reagent probes 122c pivots between the reagent containers 121 and the reaction containers 131. Each of the reagent probes 122c is moved up and down along with the associated arm portion 122b due to an up-and-down motion of the associated pivot shaft 122a. The second reagent arm 122 also has a pump that sucks the reagent from the reagent containers 121 of the second reagent storage 120 using the pump and ejects the sucked reagent to the reaction containers 131.

The sampling arm 142 is provided between the reaction disk 130 and a rack sampler 140. The sampling arm 142 also includes a pivot shaft 142a, an arm portion 142b, and a sampling probe 142c similarly to the first reagent arm 112 and the second reagent arm 122 described above. The sampling probe 142c is pivoted around the pivot shaft 142a via the arm portion 142b. The sampling probe 142c pivots at least between specimen containers 140b and the reaction containers 131. The sampling probe 142c is moved up and down along with the associated arm portion 142b due to an up-and-down motion of the associated pivot shaft 142a. The sampling arm 142 sucks test samples from the specimen containers 140b of the rack sampler 140 or the specimen containers 141a of a disk sampler 141 using the pump and ejects the sucked test samples to the reaction containers 131, respectively.

A plurality of specimen racks 140a are housed in the rack sampler 140 to be arrayed in one direction. A plurality of the specimen containers 140b are housed in each of the specimen racks 140a to be arrayed in a direction orthogonal to the array direction of the specimen racks 140a. A test sample such as blood or urine collected from a test body is stored in each of the specimen containers 140b. In the present embodiment, a barcode indicating identification information of the test samples stored in the specimen containers 140b is attached to the outer peripheral surface of the corresponding one of the specimen racks 140a.

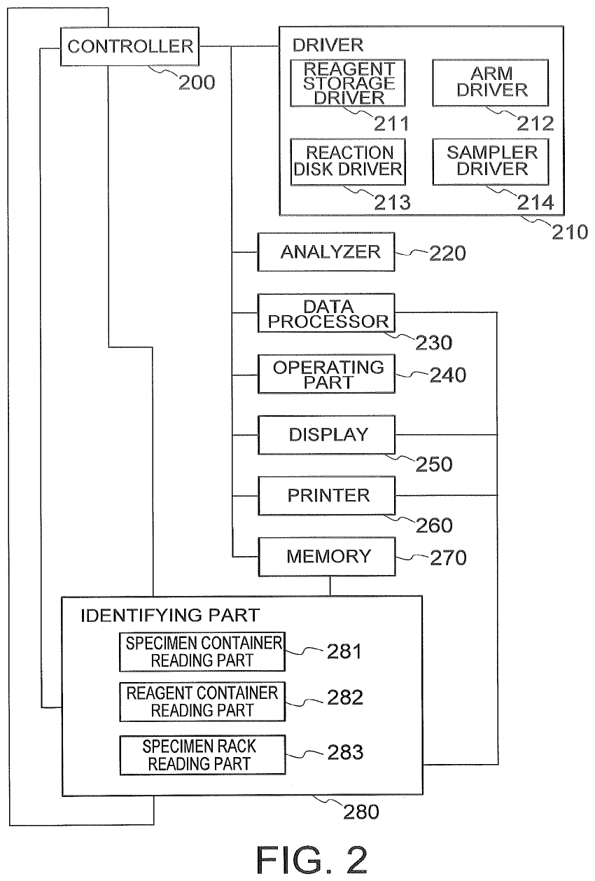

The specimen containers 141a are annularly housed in the disk sampler 141 in the manner of multiple concentric circles. A test sample such as blood or urine collected from a test body is also stored in each of the specimen containers 141a similarly to the specimen containers 140b. A barcode indicating identification information of the stored test sample is attached to the outer peripheral surface of each of the specimen containers 140b A control configuration of the automated analyzing apparatus 100 is explained below with reference to FIG. 2. FIG. 2 is a block diagram illustrating the control configuration of the automated analyzing apparatus 100 illustrated in FIG. 1. As illustrated in FIG. 2, the automated analyzing apparatus 100 includes a driver 210, an analyzer 220, a data processor 230, an operating part 240, a display 250, a printer 260, a memory 270, and an identifying part 280. These parts are controlled by a controller 200.

The controller 200 is constituted of, for example, a CPU, (Central Processing Unit), a ROM (Read Only Memory), a RAM (Random Access Memory), and the like. A control program is stored in advance in the memory 270, and the control program is appropriately loaded by the CPU into the RAM to function as the controller 200.

The driver 210 includes a reagent storage driver 211, an arm driver 212, a reaction disk driver 213, and a sampler driver 214. The reagent storage driver 211 drives the rack part of the first reagent storage 110 and the rack part of the second reagent storage 120 individually. The arm driver 212 drives the first reagent arm 112, the second reagent arm 122, and the sampling arm 142 individually. The reaction disk driver 213 drives the reaction disk 130. The sampler driver 214 drives the rack sampler 140 and the disk sampler 141 individually.

The analyzer 220 includes the agitating unit 150, the photometric unit 160, and the reaction container cleaning unit 170 illustrated in FIG. 1, and the like. The controller 200 causes the analyzer 220 to perform a series of operations (dispensing, agitating, photometry, and the like) related to analysis of test samples, various cleaning operations, or the like.

The data processor 230 processes data of standard samples or data of test samples being a result of the analysis performed by the analyzer 220 to create a calibration curve or generate analysis data. These data are transmitted to the memory 270 and are stored therein. These data are also displayed on the display 250 and are printed by the printer 260 according to an instruction of a measurer.

The operating part 240 is configured to include a keyboard, a mouse, or an electronic pen. In a case where an electronic pen is included, a touch-screen LCD (Liquid Crystal Display, for example, a tablet) is used as a display in the display 250. The operating part 240 enables input of an analysis condition such as standard samples or a calibration curve of each item, or input of various command signals.

The printer 260 receives various pieces of data from the data processor 230 and the memory 270 and performs printing of an analysis result or the like.

The identifying part 280 includes a specimen container reading part 281, a reagent container reading part 282, and a specimen rack reading part 283. These reading parts are explained below.

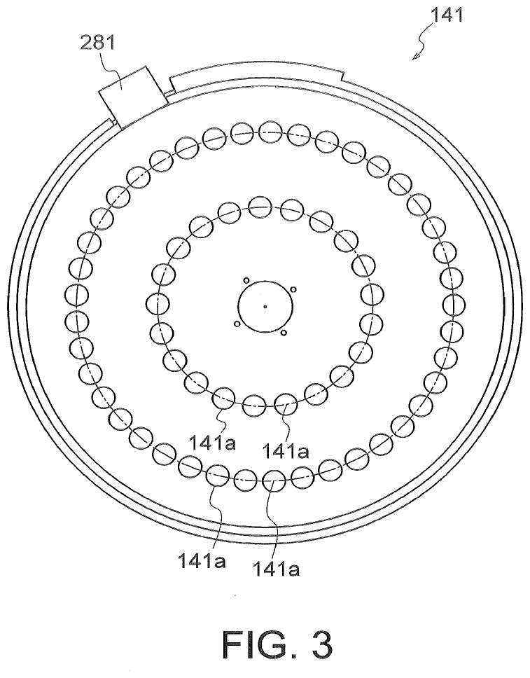

FIG. 3 is a schematic plan view of the disk sampler 141. As illustrated in FIG. 3, the specimen container reading part 281 is installed at a cutout formed in a part of a sidewall portion of the disk sampler 141. Similarly, the reagent container reading part 282 is installed at a cutout (not illustrated) formed in a part of a sidewall portion of the second reagent storage 120. The specimen rack reading part 283 is placed on a sidewall portion of the rack sampler 140.

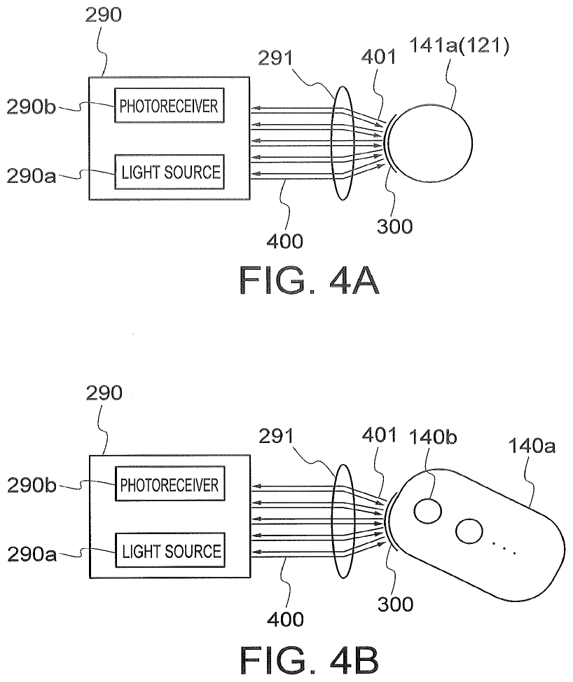

FIG. 4A is a plan view schematically illustrating a configuration of the specimen container reading part 281 and the reagent container reading part 282. As illustrated in FIG. 4A, each of the specimen container reading part 281 and the reagent container reading part 282 includes a barcode reader 290 and a cylindrical lens 291. The barcode reader 290 further includes a light source 290a and a photoreceiver 290b.

The light source 290a emits parallel light 400 toward a barcode 300 attached to one of the specimen containers 141a or the reagent containers 121 on the basis of control of the controller 200. The light source 290a is, for example, a laser light source that emits laser light as the parallel light 400.

The photoreceiver 290b receives reflected light 401 of the parallel light 400 reflected from the barcode 300. The photoreceiver 290b is constituted of, for example, a photodiode or a CCD (Charge Coupled Device) that converts the light reception intensity of the reflected light 401 into an electrical signal. A light reception result of the photoreceiver 290b is stored in the memory 270.

The cylindrical lens 291 is placed between one of the specimen containers 141a or the reagent containers 121 and the barcode reader 290. The cylindrical lens 291 refracts the parallel light 400 in a direction perpendicular to the outer peripheral surface in a curved shape of the specimen container 141a or the reagent container 121. The cylindrical lens 291 refracts the reflected light 401 into light parallel to the parallel light 400.

FIG. 4B is a plan view schematically illustrating a configuration of the specimen rack reading part 283. As illustrated in FIG. 4B, the specimen rack reading part 283 has an identical configuration to that of the specimen container reading part 281 and the reagent container reading part 282. That is, the specimen rack reading part 283 also includes the barcode reader 290 and the cylindrical lens 291. In the specimen rack reading part 283, the parallel light 400 emitted from the light source 290a of the barcode reader 290 is refracted by the cylindrical lens 291 to be applied perpendicularly to the barcode 300 attached to the outer peripheral surface in a curved shape of one of the specimen racks 140a. The reflected light 401 reflected from the barcode 300 is refracted by the cylindrical lens 291 into light parallel to the parallel light 400 and is received by the photoreceiver 290b.

Since the barcode 300 is attached to a curved surface in the embodiment described above, the parallel light 400 emitted from the barcode reader 290 diffuses in some cases when reflected from the barcode 300. In these cases, there is a possibility that the intensity of the reflected light 401 received by the photoreceiver 290b is insufficient and that a reading error occurs.

In order to solve this problem, in the present embodiment, the cylindrical lens 291 is installed between a container (the specimen container 141a or the reagent container 121) or a rack (the specimen rack 140a) to which the barcode 300 is attached, and the barcode reader 290. The cylindrical lens 291 refracts the parallel light 400 emitted from the barcode reader 290 so as to be incident on the outer peripheral surface having a curved shape of the specimen container 141a, the reagent container 121, or the specimen rack 140a in a direction substantially perpendicular thereto. Accordingly, the parallel light 400 is applied substantially perpendicularly to the attachment surface of the barcode 300 having a curved shape and light diffusion is therefore suppressed. As a result, the photoreceiver 290b can receive the reflected light 401 having a sufficient intensity to read the barcode 300, which improves the reading accuracy (the resolution) of the barcode 300.

In the present embodiment, all of the specimen container reading part 281, the reagent container reading part 282, and the specimen rack reading part 283 have the cylindrical lens 291. However, the cylindrical lens 291 does not need to be included in all the reading parts and may be provided according to the shape of the attachment surface of the barcode 300. For example, in a case where the attachment surface of the barcode 300 on the specimen rack 140a is flat, the cylindrical lens 291 is not required.

### Second Embodiment

A second embodiment is identical to the first embodiment except that the configuration of the specimen container reading part 281 and the reagent container reading part 282 is different. Therefore, the configuration of the specimen container reading part 281 and the reagent container reading part 282 will be explained below and explanations of other configurations are omitted.

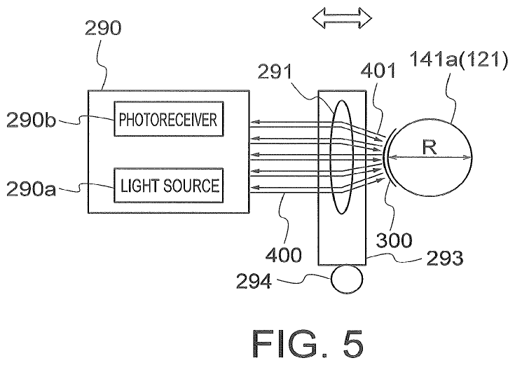

FIG. 5 is a plan view schematically illustrating the configuration of the specimen container reading part 281 and the reagent container reading part 282 according to the second embodiment. Constituent elements having an identical configuration as that of the specimen container reading part 281 and the reagent container reading part 282 according to the first embodiment illustrated in FIG. 4A are denoted by like reference signs and detailed explanations thereof are omitted.

As illustrated in FIG. 5, each of the specimen container reading part 281 and the reagent container reading part 282 according to the present embodiment further includes a stand 293 and a motor 294 in addition to the barcode reader 290 and the cylindrical lens 291. The cylindrical lens 291 is mounted on the stand 293. The motor 294 is an example of a driver and drives the stand 293 to change a linear distance between the barcode reader 290 and the cylindrical lens 291, in other words, an optical path length of the parallel light 400 on the basis of control of the controller 200.

For example, the specimen containers 141a having different diameters R are housed in the disk sampler 141 in some cases. Further, the disk sampler 141 being a holder of the specimen containers 141a has a plurality of installation portions of the specimen containers 141a and there are, for example, installation portions that are distant from the barcode reader 290 and that are located on an inner side of the disk sampler 141, and installation portions that are close to the barcode reader 290 and that are located on an outer side of the disk sampler 141. In this case, the installation portions are arranged to position the specimen containers 141a on the inner side between the specimen containers 141a on the outer side, respectively.

Similarly, the reagent containers 121 having different diameters R are housed in the second reagent storage 120 being a holder of the reagent containers 121 or the barcodes 300 having different distances from the barcode reader 290 are attached to the reagent containers 121 in some cases. In these cases, a gap for reading a barcode is formed on a part on the outer side close to the barcode reader 290 to read the barcodes 300 of the reagent containers 121 on the inner side distant from the barcode reader 290. When the barcodes 300 of the reagent containers 121 on the inner side are to be read, the barcode reader 290 reads the barcodes 300 through the gap.

In the above case, the location of the cylindrical lens 291 suitable for refracting the parallel light 400 emitted from the light source 290a of the barcode reader 290 perpendicularly to the attachment surface of the barcode 300 depends on the diameter R of the specimen container 141a or the depth of the barcode 300.

In the present embodiment, the motor 294 moves the stand 293 in a direction parallel to the optical path of the parallel light 400 according to the diameter R of the specimen container 141a or the reagent container 121 or the depth of the barcode 300, to optimize the location of the cylindrical lens 291. This can suppress light diffusion regardless of the sizes of the specimen containers 141a and the reagent containers 121 or the types of the barcodes 300, and the reading accuracy of the barcodes 300 can be therefore improved.

In the present embodiment, the amount of movement of the stand 293 by the motor 294 is previously set according to the diameter R of the specimen containers 141a and the reagent containers 121 or the depth of the barcodes 300. However, the amount of movement may be finely adjusted according to a light reception result of the photoreceiver 290b of the barcode reader 290. For example, when the controller 200 determines that the light reception intensity of the photoreceiver 290b is short of a preset reference value, the motor 294 may move the stand 293 by a preset distance on the basis of an instruction of the controller 200. In this case, the location of the cylindrical lens 291 can be optimized according to an actual measurement result of the reflected light 401. A test order, information of a test item, reagent information, and the like may include container information related to the specimen containers 141a or the reagent containers 121 to be used. The container information indicates, for example, the manufacturer name or the diameter R. In this case, the locations of the cylindrical lens 291 have been set according to the container information. Therefore, the controller 200 moves the stand 293 using the motor 294 so as to arrange the cylindrical lens 291 at a location having been set associated with the container information. Accordingly, the location of the cylindrical lens 291 can be optimized regardless of the shapes of the containers.

### Third Embodiment

A third embodiment is also identical to the first embodiment except that the configuration of the specimen container reading part 281 and the reagent container reading part 282 is different. Therefore, the configuration of the specimen container reading part 281 and the reagent container reading part 282 will be explained below and explanations of other configurations are omitted.

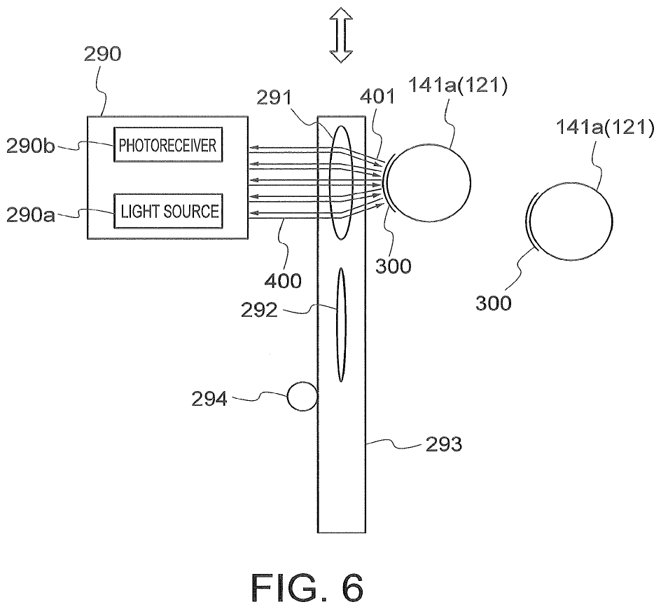

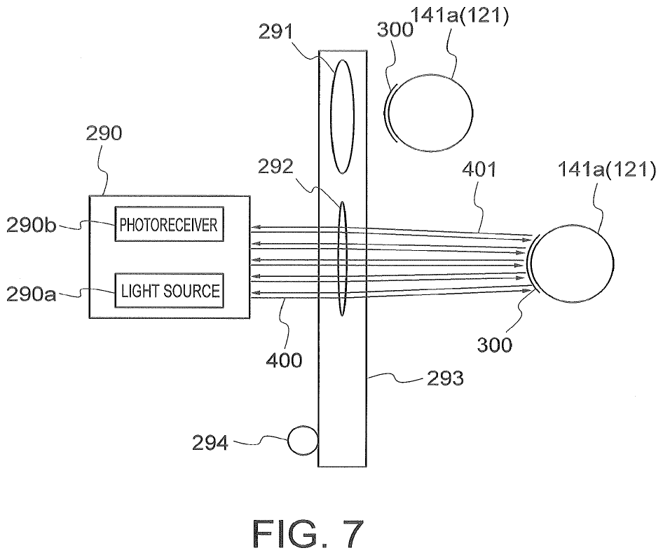

FIGS. 6 and 7 are plan views schematically illustrating the configuration of the specimen container reading part 281 and the reagent container reading part 282 according to the third embodiment. Constituent elements having an identical configuration as that of the specimen container reading part 281 and the reagent container reading part 282 according to the first embodiment illustrated in FIG. 4A are denoted by like reference signs and detailed explanations thereof are omitted.

As illustrated in FIG. 6, each of the specimen container reading part 281 and the reagent container reading part 282 according to the present embodiment further includes a cylindrical lens 292, the stand 293, and the motor 294 in addition to the barcode reader 290 and the cylindrical lens 291. The cylindrical lens 292 has a different refractive index from that of the cylindrical lens 291 and is adjacent to the cylindrical lens 291 in a direction orthogonal to the optical path of the parallel light 400. The cylindrical lens 291 and the cylindrical lens 292 are installed on the stand 293. The motor 294 drives the stand 293 to arrange the cylindrical lens 291 or the cylindrical lens 292 on the optical path of the parallel light 400 on the basis of control of the controller 200. A barcode reading operation performed by the specimen container reading part 281 according to the present embodiment is explained below.

As illustrated in FIG. 3, the specimen containers 141a are arranged in the manner of double rings in the disk sampler 141. Therefore, the barcode reader 290 of the specimen container reading part 281 first reads the barcodes 300 respectively attached to the specimen containers 141a located on the outer side one by one with rotation of the disk sampler 141. At that time, the motor 294 drives the stand 293 to place the cylindrical lens 291 on the optical path of the parallel light 400 as illustrated in FIG. 5.

When reading of the barcodes 300 attached to the specimen containers 141a on the outer side is completed, the disk sampler 141 is rotated to place any one of the specimen containers 141a located on the inner side at a location facing the barcode reader 290 as illustrated in FIG. 7. The specimen containers 141a located on the outer side and the specimen containers 141a located on the inner side are arranged to be displaced from each other in the circumferential direction. Therefore, no specimen containers 141a overlap at the location facing the barcode reader 290.

At the time when the barcode reader 290 reads the barcodes 300 attached to the specimen containers 141a located on the inner side, the motor 294 slides the stand 293 in a direction orthogonal to the optical path to place the cylindrical lens 292 on the optical path of the parallel light 400. The parallel light 400 emitted from the light source 290a is subsequently refracted by the cylindrical lens 292 to be indent on the barcodes 300 attached to the specimen containers 141a on the inner side perpendicularly to the barcodes 300.

In the reagent container reading portion 282, at the time when the barcode reader 290 reads the barcodes 300 attached to the reagent containers 121 on the outer side among the reagent containers 121 housed in the manner of double rings in the second reagent storage 120, the cylindrical lens 291 is placed on the optical path of the parallel light 400. On the other hand, at the time when the barcode reader 290 reads the barcodes 300 attached to the reagent containers 121 on the inner side, the cylindrical lens 292 is placed on the optical path of the parallel light 400.

According to the present embodiment described above, a cylindrical lens having a most appropriate refractive index is placed on the optical path according to the arrangement locations of the specimen containers 141a (the reagent containers 121) at the time when the barcode reader 290 reads the barcodes 300. As a result, light diffusion can be suppressed regardless of the arrangement locations of the specimen containers 141a (the reagent containers 121), and the reading accuracy of the barcodes 300 is therefore improved.

While the two cylindrical lenses are mounted on the stand 293 in the present embodiment, the number of cylindrical lenses may be three or more. While switching of the cylindrical lenses is performed at a timing of reading the barcodes 300 of the specimen containers 141a on the inner side after reading the barcodes 300 of the specimen containers 141a on the outer side, the switching is not limited to this timing. For example, when the controller 200 determines that the intensity of light received by the photoreceiver 290b of the barcode reader 290 is short of the preset reference value, the motor 294 may switch between the cylindrical lenses to be arranged on the optical path of the parallel light 400 on the basis of an instruction of the controller 200. In this case, a most appropriate cylindrical lens can be selected according to an actual measurement result of the reflected light 401. Further, a test order, information of a test item, reagent information, and the like may include the container information related to the specimen containers 141a or the reagent containers 121 to be used. The container information indicates, for example, the manufacturer name or the diameter R. In this case, whether the cylindrical lens 291 or the cylindrical lens 292 is to be selected has been set according to the container information. Therefore, the controller 200 moves the stand 293 using the motor 294 so as to select one of the cylindrical lens 291 and the cylindrical lens 292, which is set associated with the container information. This enables a most appropriate cylindrical lens to be selected regardless of the shapes of the containers.

### Fourth Embodiment

A fourth embodiment is also identical to the first embodiment except that the configuration of the specimen container reading part 281 and the reagent container reading part 282 is different. Therefore, the configuration of the specimen container reading part 281 and the reagent container reading part 282 will be explained below and explanations of other configurations are omitted.

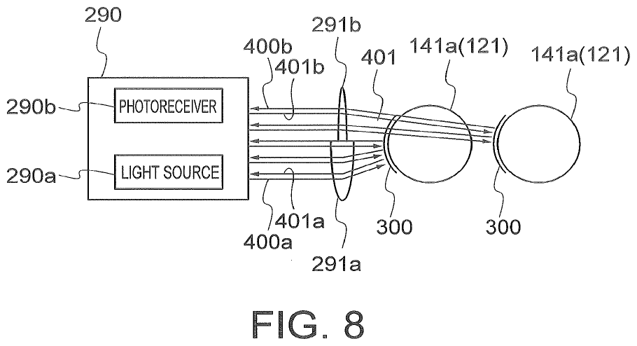

FIG. 8 is a plan view schematically illustrating the configuration of the specimen container reading part 281 and the reagent container reading part 282 according to the fourth embodiment. Constituent elements having an identical configuration as that of the specimen container reading part 281 and the reagent container reading part 282 according to the first embodiment illustrated in FIG. 4A are denoted by like reference signs and detailed explanations thereof are omitted.

As illustrated in FIG. 8, the cylindrical lens 291 has a first region 291a and a second region 291b in each of the specimen container reading part 281 and the reagent container reading part 282 according to the present embodiment. The refractive index of the first region 291a is different from that of the second region 291b.

Also in the present embodiment, the barcode reader 290 reads the barcodes 300 in the order of those of the specimen containers 141a on the outer side and those of the specimen containers 141a on the inner side similarly to the third embodiment. As illustrated in FIG. 8, at the time when the barcode reader 290 reads the barcodes 300 attached to the specimen containers 141a on the outer side, parallel light 400a emitted from the light source 290a is refracted in the first region 291a of the cylindrical lens 291 to be applied to the barcodes 300 attached to the specimen containers 141a on the outer side. Subsequently, reflected light 401a reflected from the barcodes 300 is also refracted in the first region 291a to be received by the photoreceiver 290b.

The light source 290a also emits parallel light 400b along with the parallel light 400a. The parallel light 400b is refracted in the second region 291b of the cylindrical lens 291. However, one of the specimen containers 141a on the outer side is arranged at a location facing the barcode reader 290, that is, a reading location of the barcodes 300 while the specimen containers 141a on the inner side do not face the barcode reader 290. Therefore, the light refracted in the second region 291b is not applied to the barcodes 300 attached to the specimen containers 141a on the inner side and accordingly these barcodes 300 are not read.

When reading of the barcode reader 290 attached to the specimen containers 141a on the outer side is completed, one of the specimen containers 141a on the inner side is arranged at a location facing the barcode reader 290. Subsequently, the parallel light 400a and 400b are emitted from the light source 290a. While the parallel light 400a is refracted in the first region 291a, the refracted light is not applied to the barcodes 300 attached to the specimen containers 141a on the outer side. Meanwhile, the parallel light 400b is refracted in the second region 291b and is applied to the barcodes 300 attached to the specimen containers 141a on the inner side. Subsequently, reflected light 401b reflected from the barcodes 300 is also refracted in the second region 291b to be received by the photoreceiver 290b.

In the reagent container reading part 282, light refracted in the first region 291a of the cylindrical lens 291 is applied to the barcodes 300 at the time when the barcode reader 290 reads the barcodes 300 attached to the reagent containers 121 on the outer side. Meanwhile, at the time when the barcode reader 290 reads the barcodes 300 attached to the reagent containers 121 on the inner side, light refracted in the second region 291b of the cylindrical lens 291 is applied to the barcodes 300.

According to the embodiment described above, light refracted in a region of a cylindrical lens having a most appropriate refractive index is applied to the barcodes 300 according to the arrangement location of the specimen containers 141a (the reagent containers 121) at the time when the barcode reader 290 reads the barcodes 300. As a result, light diffusion can be suppressed regardless of the arrangement locations of the specimen containers 141a (the reagent containers 121) and the reading accuracy of the barcodes 300 is accordingly improved.

According to at least one of the embodiments described above, the reading accuracy of the barcode 300 can be improved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An automated analyzing apparatus comprising:
a barcode reader configured to emit light toward a barcode attached to at least one of a specimen container storing a test sample, a reagent container storing a reagent to be reacted with the test sample, and a specimen rack housing a plurality of the specimen containers arranged in a line, and configured to read the barcode on a basis of reflected light of the applied light; and
a cylindrical lens placed between at least one of the specimen container, the reagent container, and the specimen rack, and the barcode reader.

2. The apparatus of claim 1, wherein
the barcode is attached to at least one of outer peripheral surfaces in a curved shape of the specimen container, the reagent container, and the specimen rack, and
the cylindrical lens refracts light emitted from the barcode reader in a direction where an incident angle of the light to the outer peripheral surface is close to perpendicular.

3. The apparatus of claim 1, wherein
the barcode is attached to at least one of outer peripheral surfaces in a curved shape of the specimen container, the reagent container, and the specimen rack, and
the cylindrical lens refracts light emitted from the barcode reader in a direction perpendicular to the outer peripheral surface.

4. The apparatus of claim 1, further comprising a driver configured to move the cylindrical lens so as to change a linear distance between the barcode reader and the cylindrical lens.

5. The apparatus of claim 1, further comprising:
a stand configured to include a plurality of the cylindrical lenses to be installed thereon, the lenses having refractive indexes different from each other; and
a driver configured to drive the stand so as to arrange any one of the cylindrical lenses on an optical path of the light.

6. The apparatus of claim 5, wherein the cylindrical lenses are adjacent to each other in a direction orthogonal to the optical path.

7. The apparatus of claim 1, further comprising:
a holder configured to hold a plurality of the specimen containers or a plurality of the reagent containers and to include a plurality of holding locations where a distance between the barcode reader and the holder is different; and
a driver configured to move the cylindrical lens according to holding locations of the specimen containers or the reagent containers having the barcodes to be read.

8. The apparatus of claim 1, wherein
a plurality of the specimen containers or a plurality of the reagent containers are arrayed in multiple layers,
the cylindrical lens has a plurality of regions having refractive indexes different from each other, and
the light is applied to a barcode attached to each of the specimen containers or the reagent containers after being refracted in any one of the regions.

9. The apparatus of claim 8, wherein the regions are adjacent to each other in a direction orthogonal to an optical path of the light.

10. The apparatus of claim 5, further comprising a controller configured to control the driver on a basis of a result of light receiving of the reflected light by the barcode reader.

11. The apparatus of claim 4, further comprising a controller configured to control the driver so as to cause the linear distance to have a value set associated with container information related to the specimen container or the reagent container.

12. The apparatus of claim 5, further comprising a controller configured to control the driver to enable selection of one of the cylindrical lenses set associated with container information related to the specimen container or the reagent container.
